(19) United States
(12) Patent Application Publication
(10) Pub. No.: US 2017/0357778 A1
(43) Pub. Date: Dec. 14, 2017

(54) TRANSPARENCY TRACKER

(71) Applicant: MMS Holdings Inc., Canton, MI (US)

(72) Inventors: Patrick Joseph Archer, South Lyon, MI (US); Jin Seuk Park, Canton, MI (US); Zachary Thomas Weingarden, Grosse Pointe Woods, MI (US)

(21) Appl. No.: 15/620,606

(22) Filed: Jun. 12, 2017

Related U.S. Application Data
(60) Provisional application No. 62/348,464, filed on Jun. 10, 2016.

(51) Int. Cl. G06F 19/00; G06F 3/0482; G06F 17/30; G06F 3/0485

(52) U.S. Cl. CPC G06F 19/363; G06F 3/0485; G06F 3/0482; G06F 17/30011

(57) ABSTRACT

The clinical trial data management system disclosed herein provides for a transparency tracker with an integrated lifecycle workflow dashboard that navigates clinical trial protocols through disclosure lifecycle stages and workflow modules with scrollable timelines, integrated data screens of supporting information, and integrated document repositories and reporting systems for managing information exchange.

### CROSS-REFERENCE TO RELATED APPLICATION

The present application is a Non-Provisional application, which claims the priority and benefit of U.S. Provisional Application Ser. No. 62/348,464 filed on Jun. 10, 2016 and entitled “TRANSPARENCY TRACKER,” which is incorporated herein by reference in its entirety.

### FIELD

Implementations disclosed herein relate, in general, to information management technology and specifically to clinical trial data management.

### SUMMARY

The clinical trial data management system disclosed herein provides for a transparency tracker with an integrated lifecycle workflow dashboard that navigates clinical trial protocols through disclosure lifecycle stages and workflow modules with scrollable timelines, integrated data screens of supporting information, and integrated document repositories and reporting systems for managing information exchange.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example graphical user interface (GUI) representing an integrated lifecycle workflow dashboard disclosed herein.

FIG. 2 illustrates an alternative example GUI representing an integrated lifecycle workflow dashboard disclosed herein.

FIG. 3 illustrates another example GUI representing an integrated lifecycle workflow dashboard disclosed herein.

FIG. 4 illustrates an example GUI for protocol filters.

FIG. 5 illustrates another example GUI for task filters.

FIG. 6 illustrates the drop-down menus listing lifecycle choices within an integrated lifecycle workflow dashboard.

FIG. 7 illustrates an example schematic of a scrollable timeline.

FIG. 8 illustrates an example computing system that may be useful in implementing the described technology.

FIG. 9 illustrates a block diagram illustrating a transparency tracker system disclosed herein.

### DETAILED DESCRIPTION

In life science industry, clinical trials of drugs and treatments are highly regulated by various government laws and regulations. For example, organizations participating in clinical trials are required to disclose clinical trial data into the public domain (e.g., internet) and track the quality, compliance and completeness of information. The industry has been under attack by the general-public, healthcare professionals, journal editors, media, and legislators for not disclosing all applicable clinical trial information. Some estimates are that over seventy percent of summary disclosures are missing, incomplete, or inaccurate. As a result, these organizations are often out of compliance of disclosure laws, which may result in delays, fines, and a negative public image, etc.

Although the criticism is that the Industry is intentionally hiding the information, the reality is that sponsors of clinical trials don't have the tools to manage and track a very complex workflow, and many are attempting but failing to comply. “Clinical trial disclosures” as they are called, encompasses the posting of the following information on the Internet:
protocol registrations (timing: prior to study start)
site and status updates of the protocol (timing: within 30 days of change)
results reporting (timing: within a year of study completion)

The benefit of making this information publically available is to help limit publication bias and to reduce redundant testing by ensuring an accountability of trials conducted and reporting of the results regardless of a positive or negative outcome to remove any kind of selection bias from the reported data.

The main deliverable derived from the transparency laws are protocol, site and results summaries of the clinical trial information. From an operational standpoint to fulfill these requirements each study may have to navigate through a number of workflow steps across a number of different lifecycle stages with fluctuating and intermittent reporting periods spanning across several years (per study) depending on the following parameters:
study start
site and status changes
study completion
drug approval dates

Also, one or more of the above parameters may deviate based on country requirements, etc. With at least fifteen countries with mandatory requirements and unique websites, clear guidelines are necessary.

A centralized business model (versus decentralized) is generally used to facilitate this workflow for a mid to large size pharmaceutical company. The biggest challenge a central disclosure team endures is the managing of the many moving pieces of the information exchange while meeting quality and compliance objectives. This may be easily managed if a sponsor was responsible for just a few studies, but many organizations can manage several hundred studies at any time and therefore managing the trials becomes a challenge.

A clinical data management and reporting system disclosed herein provides a graphical user interface (GUI) in the form of an integrated lifecycle workflow dashboard within a transparency tracker module. An example implementation of such dashboard features, without limitation, would include the following items:
Navigational capabilities for each clinical trial protocol identification (ID) to move sequentially through disclosure lifecycle stages with direct access to workflow-specific screen modules required during each stage.
A scrollable timeline that allows a user to record a start/stop dates and descriptions for each touch point within a workflow step.
Integrated data screens of supporting information to help facilitate each workflow step.
Integrated document repositories and reporting systems to facilitate the internal and external information exchange.
Sortable and filterable lists of tasks pertaining to in-process studies.
Generation of date-driven delinquency and non-compliance findings.
Ability to view study data with outstanding validations and queries attached to data fields
Display of auto-generated system notification.
Automatic tracking for new registries driven from geographic criteria, such as a site in a new country or a product submission planned for a particular agency.

Specifically, the clinical data management system disclosed herein provides a solution to the compliance issues in the life science industry including a transparency tracker module with an integrated lifecycle workflow dashboard that allows a user to navigate a clinical trial sequentially through screen modules dedicated to each of the workflow steps. In each workflow module, a staff member has specific task guidelines that must be completed, and once the tasks are completed the trial would navigate to the next required workflow step with a separate set of task instructions.

For example, in the illustrated implementation, the integrated workflow includes ten modules. However, in alternative implementations, more or less than ten modules may be provided. The example set of the ten workflow steps are aligned to each of the six lifecycle stages, and the lifecycle stages are tied to the reporting of summary information that is federally required to be posted on the Internet during that stage. To assist with the navigating from one stage to the next, a unique lifecycle status is assigned at each stage.

Lifecycle statuses are aligned with workflow statuses and sequenced to meet the reporting requirements for each lifecycle stage. For example, as the protocol-level information is the first piece of information reported, a Protocol lifecycle status of “Initiation” would be assigned, and the workflow steps tied to the initial summarization and release of information would be performed. After all the workflow steps are completed within this lifecycle stage and the required information is reported, the next lifecycle status is then assigned where workflow steps may be tied to providing post-release updates of facility site and status information. After a series of Lifecycle statuses at the protocol-level, and after the protocol information has been fully reported, then the Protocol lifecycle status is “Closed” and a Results Lifecycle status of “Initiation” may be assigned. This is an example of how a study would navigate through workflow steps tied to several lifecycle stages (note: the lifecycle stages are generally defined by regulatory requirements or company policies).

From a systems design perspective, the “screen modules” provided herein organizes all studies within a Lifecycle or a Workflow step together, so a staff member may follow the same task guidelines for all studies listed on each screen. The lifecycle stages are listed on page 7 of this document. The workflow step names are self-explanatory on what tasks would be completed for each; here is a list:
Tracking,
Assessment,
Document Management,
Summarization,
Review,
Quality Control,
Approval,
Release,
Registry Queue Response, and
Monthly Updates

Note that when a study is within a workflow step, tracking information such as start and stop dates are collected and displayed on the scrollable timeline. This helps track delinquencies at each stage.

In summary, the clinical trial management system disclosed herein is engineered with proper sequencing of Lifecycle and Workflow statuses, and an alignment of screen modules tied to workflow steps with specific task guidelines and tracking fields. This helps keep a study on track for compliance with the law. One or more features of the clinical trial management system disclosed herein are disclosed in detail in the following figures.

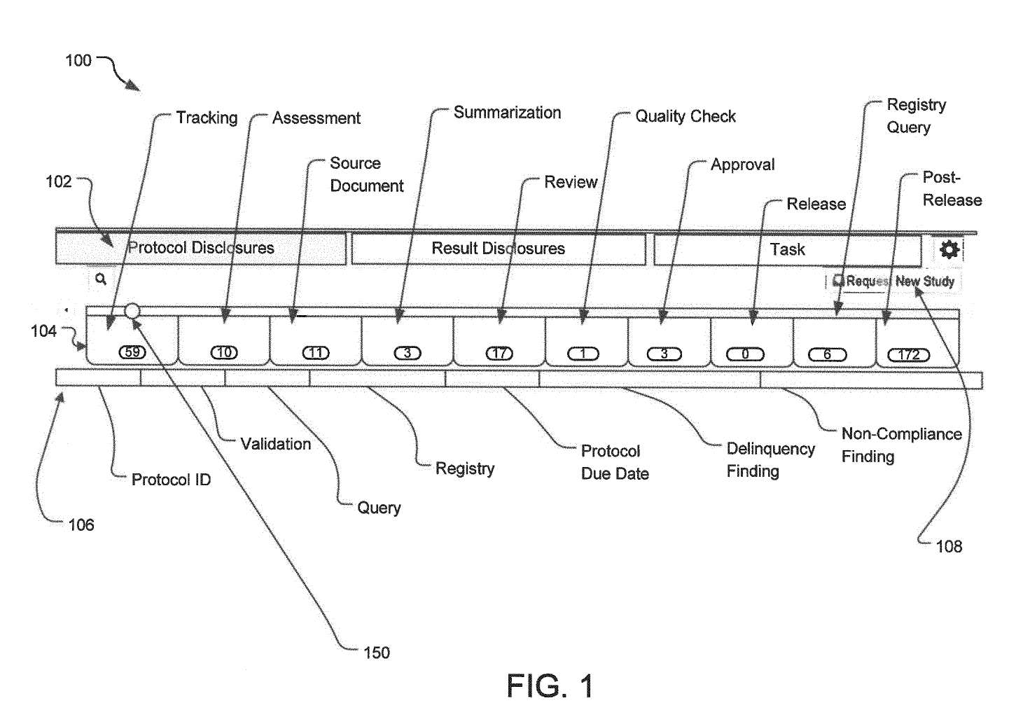

FIG. 1 illustrates an example graphical user interface (GUI) 100 representing the integrated lifestyle workflow dashboard disclosed herein. Specifically, FIG. 1 illustrates a GUI 100 with a protocols disclosures tab 102 selected by a user. Selecting of the protocol disclosures tab 102 results in the GUI 100 including various sub-tabs 104 disclosing various studies by their protocol ID and the number of studies at each stage. Specifically, as disclosed in FIG. 1, selecting the protocol disclosures tab 102 results in sub-tabs 104 showing that there are 59 studies in a tracking stage, 10 studies in an assessment stage, 11 studies in source document stage, etc. Furthermore, the GUI 100 also includes various headers 106 including a study specific information for studies at the tracking stage (selected herein). Thus, a list of studies will be displayed at the tracking stage with their protocol ID, validation status, query status, etc. The headers 106 are configurable and users can add or remove one or more headers as necessary. A user can request a new study by selecting the button 108.

The GUI 100 also includes a tracker 150 that a user may use to select from one of the various sub-tabs 104. For example, the user may move the tracker 150 above the summarization sub-tab to view information about three (3) studies at the summarization stage.

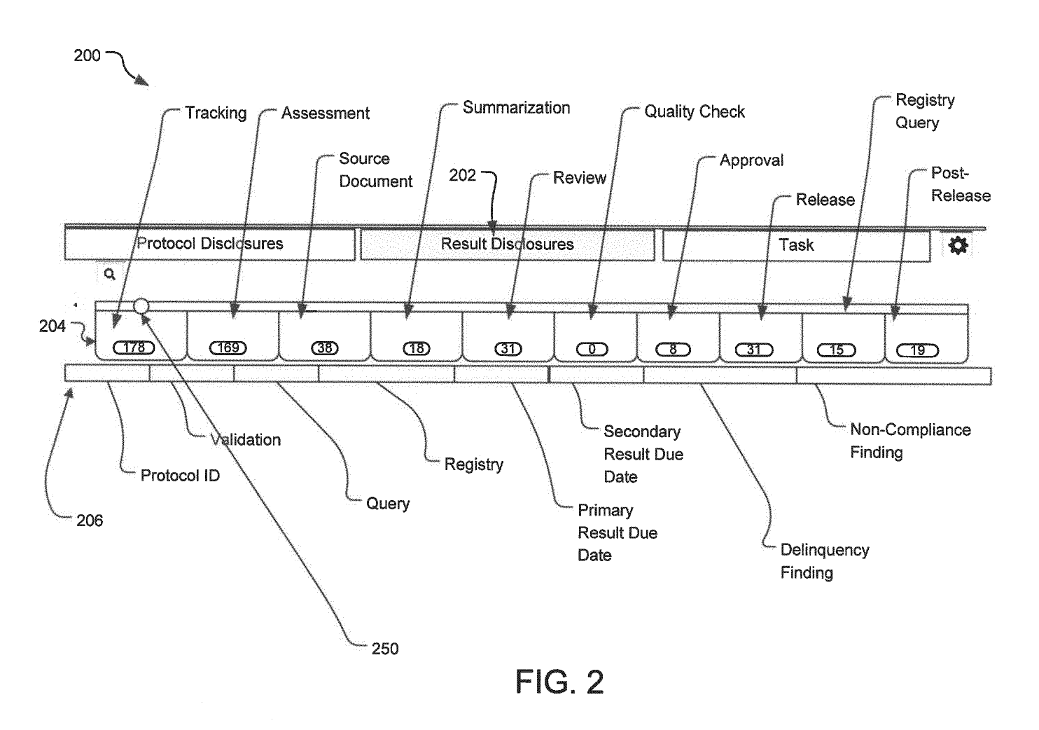

FIG. 2 illustrates another tab of a GUI 200 representing the integrated lifestyle workflow dashboard disclosed herein. Specifically, FIG. 2 illustrates the GUI 200 with a results disclosure tab 202 selected by a user. Selecting of the result disclosures tab 202 results in the GUI 200 including various sub-tabs 204 disclosing various studies by their protocol ID and the number of studies at each stage with the results. Specifically, as disclosed in FIG. 2, selecting the result disclosures tab 202 results in sub-tabs 204 showing that there are 178 studies in a tracking stage, 169 studies in an assessment stage, 38 studies in source document stage, etc. Furthermore, the GUI 200 also includes various headers 206 including a study specific information for studies at the tracking stage (selected herein). Thus, a list of studies will be displayed at the tracking stage with their protocol ID, validation status, query status, etc. The headers 206 are configurable and users can add or remove one or more headers as necessary.

The GUI 200 also includes a tracker 250 that a user may use to select from one of the various sub-tabs 204. For example, the user may move the tracker 250 to the approval sub-tab to view information about thirty-one (31) studies at the approval stage.

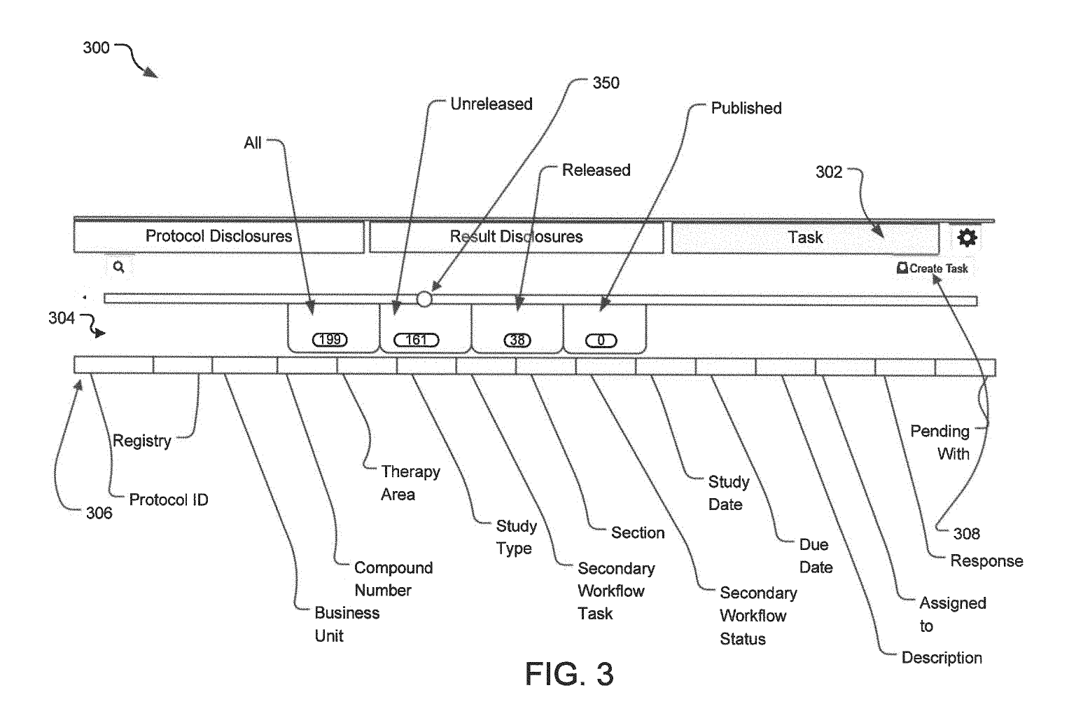

FIG. 3 illustrates another tab of the GUI 300 representing the integrated lifestyle workflow dashboard disclosed herein. Specifically, FIG. 3 illustrates the GUI 300 with a task tab 302 selected by a user. Selecting of the task tab 302 results in the GUI 300 including various sub-tabs 304 disclosing various tasks studies by their protocol ID and the number of studies with their status. Specifically, as disclosed in FIG. 3, selecting the task tab 302 results in sub-tabs 304 showing that there are 199 total studies, 169 unreleased studies, 38 released studies, and no published study. Furthermore, the GUI 300 also includes various headers 306 including a study specific information for unreleased studies (selected herein). Thus, a list of unreleased studies will be displayed with their protocol ID, registry, business unit, etc. The headers 306 are configurable and users can add or remove one or more headers as necessary. A user can create a new task by selecting the button 308.

The GUI 300 also includes a tracker 350 that a user may use to select from one of the various sub-tabs 304. For example, the user may move the tracker 350 to the released sub-tab to view information about thirty-eight (38) released studies.

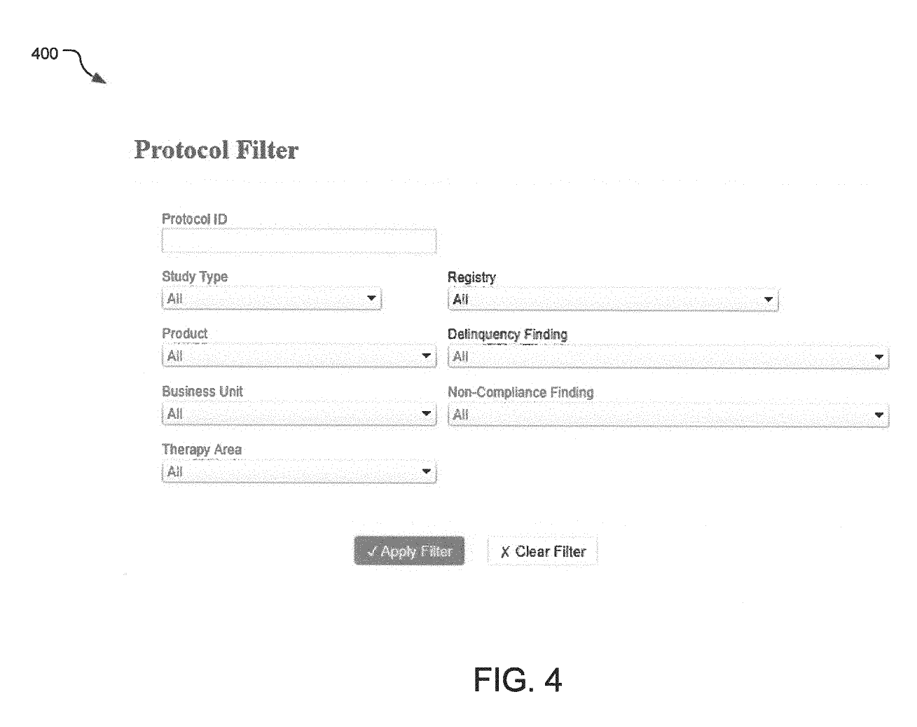

FIG. 4 illustrates a protocol filter GUI 400 for selecting a protocol. A user can select one or more of the various parameters, such as study type, registry, product, business unit, etc., to select a protocol.

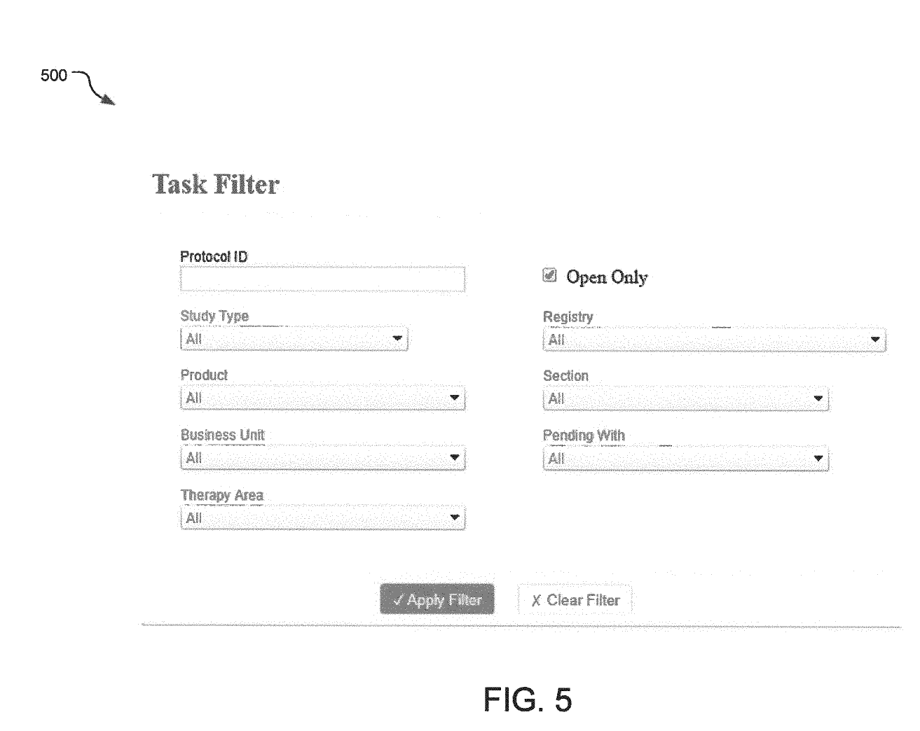

FIG. 5 illustrates a task filter GUI 500 for selecting a task. A user can select one or more of the various parameters, such as study type, registry, product, business unit, etc., to select a task.

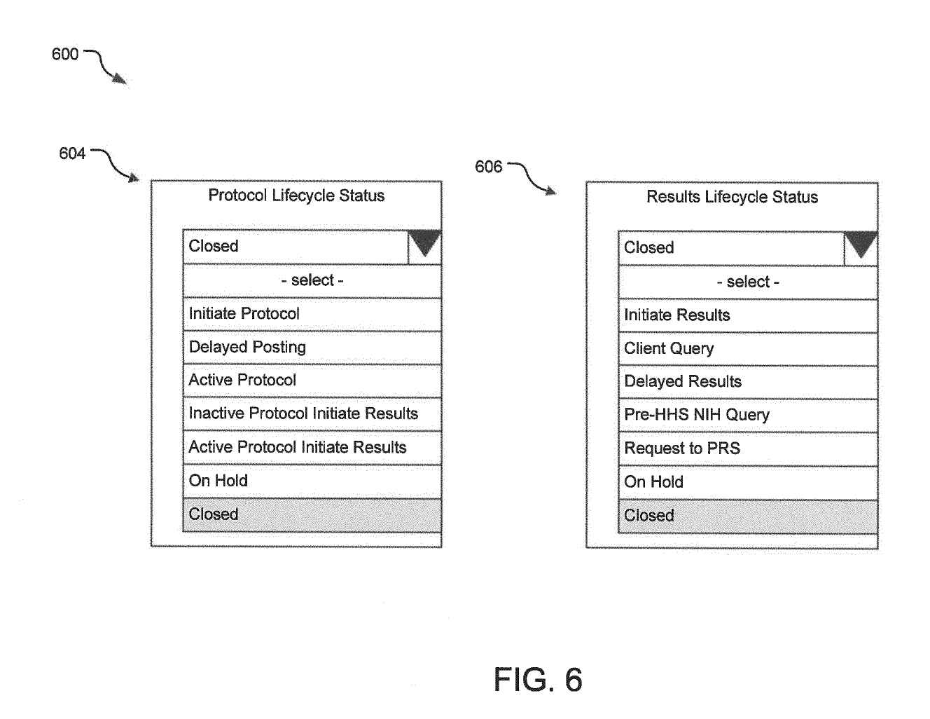

FIG. 6 illustrates the drop-down menus 600 listing lifecycle choices. Specifically, a drop-down menu 604 illustrates options for selecting a status for protocol lifestyle whereas a down menu 606 illustrates options for selecting a status for results lifestyle.

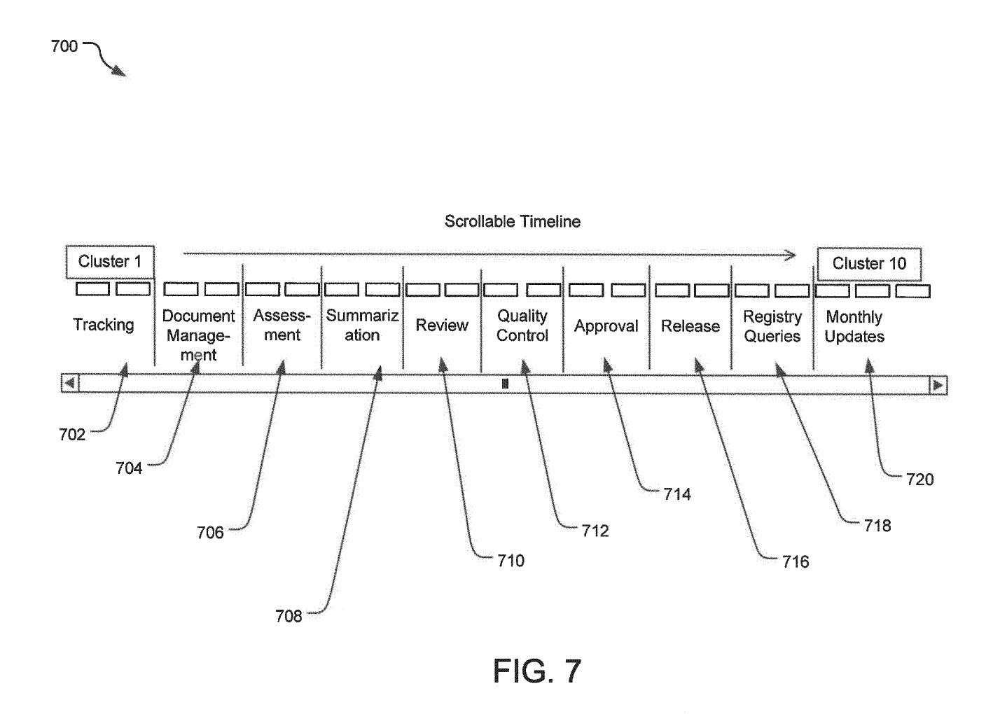

FIG. 7 illustrates an example flow chart 700 representing various workflow steps of the integrated dashboard. Specifically, the flowchart 700 illustrates each of the steps 702-720 for workflow. Note that while the steps 702-720 are listed as flowing sequentially, in one implementation, the user may be able to move in an alternative manner. For example, generally, if a study is in the assessment module 704 the study moves to the document management module 706 after completion of the assessment module 704. However, the sequencing of these workflow steps can be configured to meet differing client needs. Furthermore, while the flowchart 700 includes ten steps, alternatively more or less number of steps may be provided. Each of the steps 702-720 are described below:

702: Study is under the “Tracking” step. The study could be planned, ongoing, or completed but the disclosure workflow has not been initiated

704: Study is under the “Document Management” step. The disclosure lead is gathering source materials necessary to complete the disclosure summarization. This could include, but not limited to, study protocols, protocol amendments, statistical analysis plans, clinical study reports, site information, adverse event listings, as well as study result tables, listings, figures, graphs, and datasets.

706: Study is under the “Assessment” step. The disclosure lead is determining which global registries are in scope based on study parameters, legal requirements, and organizational policy.

708: Study is under the “Summarization” step. The study protocol or results are being summarized in a format that is acceptable by the planned registries.

710: Study is under the “Review” step. Study team members and other sponsor representatives review the summarization information and provide comments and updates.

712: Study is under the “Quality Control” step. The QC team reviews the study summarization against the source documents to ensure the information is accurate.

714: Study is under the “Approval” step. The designated sponsor approver provides final sign-off on the summarization before it is posted publicly.

716: Study is under the “Release” step. The protocol or results summarization is sent to the registry. This can be done via interface with the registry, producing output designed for registry upload, or producing a report to facilitate manual entry.

718: Study is under the “Registry Queries” step. The protocol or results summarization has been received by the registry and the disclosure lead addresses queries from the governing body of the registry.

720: Study is under the “Monthly Updates” step. The summarization has been accepted and published by the registry. Ongoing updates are made as the study progresses, per registry requirements

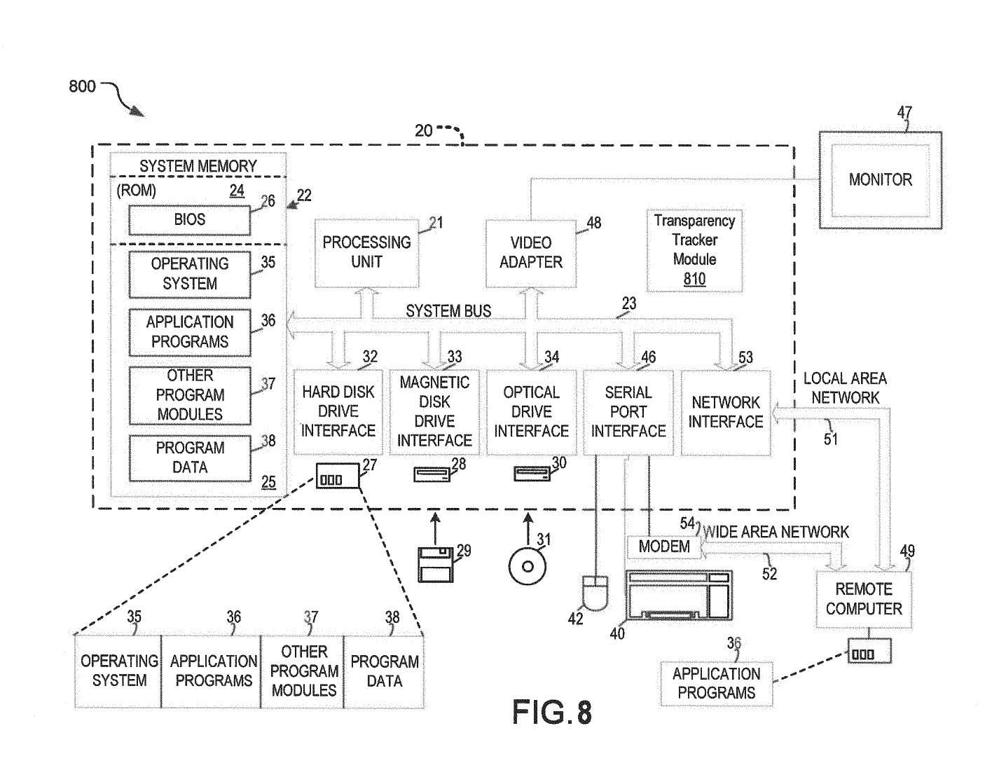

FIG. 8 illustrates an example computing system that may be useful in implementing the described technology. The example hardware and operating environment of FIG. 8 for implementing the described technology includes a computing device, such as general purpose computing device in the form of a gaming console or computer 20, a mobile telephone, a personal data assistant (PDA), a set top box, or other type of computing device. In the implementation of FIG. 8, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media which can store data that is accessible by a computer, such as magnetic cassettes, flash memory cards, digital video disks, random access memories (RAMs), read only memories (ROMs), and the like, may be used in the example operating environment. A transparency tracker module 810 may be implemented on the computer 20 to generate one or more of the dashboard GUI disclosed herein. The transparency tracker module 810 may include one or more computer readable instructions that are stored in memory 22 and executed by the processing unit 21.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. A communication device coupled to or a part of the computer 20 achieves these logical connections; the implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 8. The logical connections depicted in FIG. 8 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, software or firmware instructions and data for providing a search management system, various applications, search context pipelines, search services, service, a local file index, a local or remote application content index, a provider API, a contextual application launcher, and other instructions and data may be stored in memory 22 and/or storage devices 29 or 31 and processed by the processing unit 21.

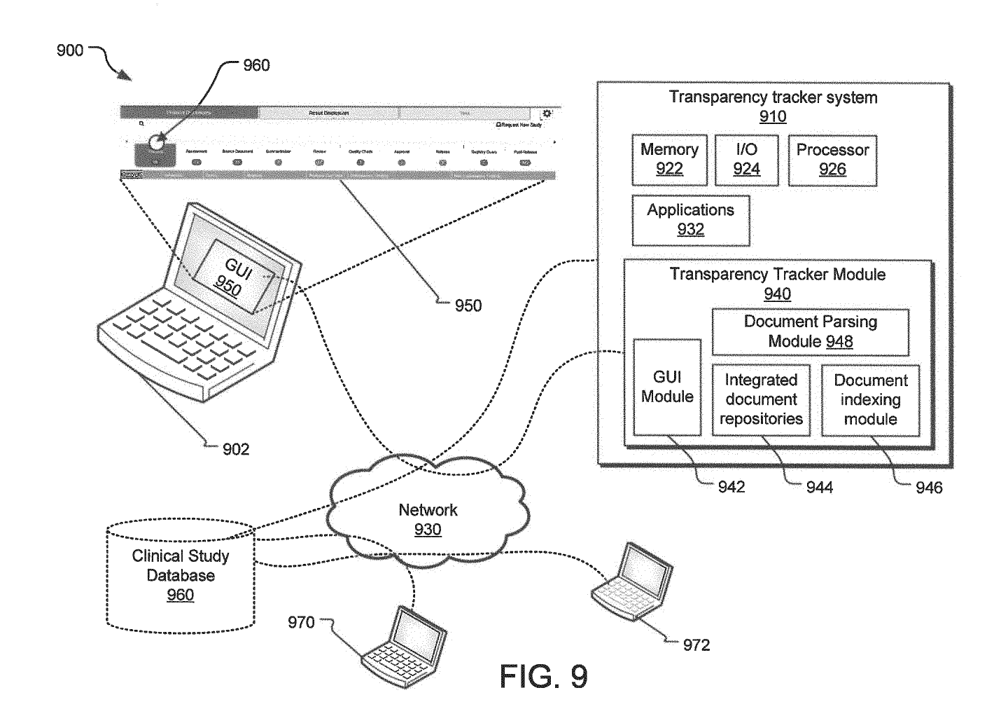

FIG. 9 illustrates a block diagram illustrating a transparency tracker system 900 disclosed herein. Specifically, the transparency tracker system 900 includes a transparency tracker system 910. The transparency tracker system 910 allows a user to track a plurality of clinical studies at various stages. The transparency tracker system 910 may be implemented on a server, on a cloud environment, etc. The transparency tracker system 910 includes a memory 922, I/O module 924, a processor 926, and various applications 932, including a transparency tracker module 940. The transparency tracker module 940 includes a GUI module 942, integrated document repositories 944, and a document indexing module 946 that allows documents to be indexed between various clinical trial stages and document repositories.

The document indexing module 946 indexes each of various clinical trials and documents related to such trials with the stage of the clinical trial. Thus, for example, if a clinical trial related to a protocol A is at assessment stage, documents and records related to the protocol A are indexed to be at assessment stage. Furthermore, the document indexing module 946 updates the index of a given clinical study based on an update received from a user. For example, if a clinical trial B is at document management stage, once all the documents related to the clinical trial B are received, the document indexing module 946 updates the clinical trial B to be at the assessment stage.

Thus, for example, a user managing a clinical trial C may identify the documents that are required for the clinical trial C. Various users at various locations 970, 972, may upload documents required for the clinical trial C to the clinical trial database 960. The transparency tracker module 940 keeps track of the required documents as they are received by the clinical trial database 960 and updates the status and indexing of the clinical trial C as these documents are received. In one implementation, the transparency tracker module 940 further includes a document parsing module 948 that parses the documents uploaded to the clinical trial database 960 to identify the appropriate clinical trial for which the document is applicable, whether the document is complete, and to change the status of the clinical trial.

The transparency tracker module 940 is further configured to implement various steps of the flowchart 700 (specifically 402-720) to move various clinical trials between appropriate steps. As the clinical trial moves between various stages as per the operations of the flowchart 700, the document indexing module 946 identifies the documents and trials to one or more of their appropriate stages. For example, when a clinical trial (study) E is at the assessment stage 706, the document indexing module 946 identifies the various documents related to that trial E be at assessment stage. Once all the disclosure lead for the trial E has identified the appropriate global registries, legal requirements, organizational policy, etc., and certified that the trial E assessment is complete, the transparency tracker module 940 moves the trial E and related information to summarization stage with appropriate indexing.

The transparency tracker system 910 may communicate with a clinical study database 960 using a network 930, such as the Internet. The transparency tracker system 910 may be used by a user using a computer, such as a laptop 902 to track various clinical trials using a GUI 950. The GUI module 942 receives input from the GUI 950 in form of a tracker and in response to the input from the tracker, selects information about various clinical trials to be disclosed to the user via the GUI 950. The GUI 950 provides the user a tracker control 960 that the user may move over the GUI 950 to select clinical trials/studies at various stages. In response to the movement of the tracker 960, the GUI module 942 selects appropriate clinical trials from the integrated document repositories 944 and its related information to be displayed on the GUI 950.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

Implementations of the present technology are disclosed herein in the context of an electronic market system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations disclosed herein may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one implementation of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one implementation of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary implementations disclosed herein. Although various implementations disclosed herein have been described above with a certain degree of particularity, or with reference to one or more individual implementations, those skilled in the art could make numerous alterations to the disclosed implementations without departing from the spirit or scope of this invention. In particular, it should be understood that the described technology may be employed independent of a personal computer. Other implementations are therefore contemplated. It is intended that all matter contained in the above description and shown in the accompanying drawings shall be interpreted as illustrative only of particular implementations and not limiting. Changes in detail or structure may be made without departing from the basic elements disclosed herein as defined in the following claims.

What is claimed is:

1. A system comprising:
a graphical user interface (GUI) for an integrated lifecycle workflow displaying a selection menu for lifecycle status of a clinical trial, the GUI allowing a user to navigate a clinical trial through a plurality of disclosure lifecycle stages;
a scrollable timeline that allows a user to move between plurality of workflow stages;
a plurality of integrated data screens for disclosing supporting information related to each of the plurality of workflow stages; and
a plurality of integrated document repositories and reporting systems for managing information exchange between the workflow stages.

2. The system of claim 1, further comprising a document indexing module configured to index each of various clinical trial documents to various disclosure lifecycle stages.

3. The system of claim 1, further comprising a GUI module configured to receive input from the GUI in form of a tracker location.

4. The system of claim 4, wherein the GUI module further configured to select one or more documents from the integrated document repositories based on the tracker location to be displayed via the GUI.

5. The system of claim 4, wherein the tracker location identifies clinical trials at a selected clinical trial state.

6. The system of claim 4, further comprising a document indexing module configured to update the index of a clinical trial based on the clinical trial meeting a predetermined condition.

7. The system of claim 1, further comprising a document parsing module configured to parse documents uploaded to a clinical study database and to allocate the document to one of the clinical trials.
